(19) United States
(12) Patent Application Publication
(10) Pub. No.: US 2005/0169602 A1
(43) Pub. Date: Aug. 4, 2005

(54) Apparatus, method, and system for video signal recording and playback

(75) Inventors: Teruo Tajima, Tokyo (JP); Motohiro Suzuki, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/040,009

(22) Filed: Jan. 24, 2005

(30) Foreign Application Priority Data
Feb. 4, 2004 (JP) 2004-028410

(51) Int. Cl. H04N 5/76; H04N 5/781

(52) U.S. Cl. 386/46; 386/125

(57) ABSTRACT

A video signal recording and playback apparatus includes: a unit for checking at least one external video device connected to a main unit via a predetermined interface to determine a video device which is recording, the main unit having a control section for transmitting and receiving video signals to/from at least one video device and controlling the device; a unit for checking at least one video device connected via the predetermined interface to determine a video device capable of performing playback while recording; a unit for determining a video device, which is recording and is capable of performing playback while recording, at least one video device as a control target connected via the predetermined interface and determining playback with respect to the control target device in recording; and a unit for allowing the control target device in recording to perform the determined playback when an operation section is operated.

### CROSS-REFERENCE TO RELATED APPLICATIONS

This application is based upon and claims the benefit of priority from the prior Japanese Patent Application No. 2004-28410 filed on Feb. 4, 2004; the entire contents of which are incorporated herein by reference.

### BACKGROUND OF THE INVENTION

1. Field of the Invention

The present invention relates to a video signal recording and playback apparatus, method, and system for recording digital video signals to a high-speed accessible recording medium and playing back the signals and, more particularly, to a video signal recording and playback apparatus and system, connected to an interface of IEEE1394, having a function of playing back recorded data while recording data to a video device such as a hard disk recorder, a video signal recording and playback method, and a video signal recording and playback system.

2. Description of the Related Art

Hitherto, a video signal supplied from a signal source or a received television broadcast signal has been recorded on a video tape as a recording medium through a video tape recorder (VTR). Recently, a hard disk recorder using a hard disk with high random access performance is in practical use. Further, a hard disk/DVD recorder for recording and playback using a DVD as a recording medium in addition to a hard disk is also in practical use.

A hard disk drive device (HDD device), using the above- mentioned hard disk as a recording medium, records and plays back video signals using a randomly accessible recording medium. Since access time to the recording medium is short, the HDD device has a function capable of simultaneously recording a digital video signal and playing back the recorded video signal.

For example, a video signal recording and playback apparatus with the above-mentioned simultaneous recording and playback function has a chase play function for performing playback while recording such that a recorded signal follows a signal which is being recorded currently.

A known video signal recording and playback apparatus having the above-mentioned functions is disclosed in, for example, Japanese Unexamined Patent Application Publication No. 2001-167521. According to Japanese Unexamined Patent Application Publication No. 2001-167521, when recording start is instructed, a recording process is executed. After that, when playback start is instructed, a playback process is executed. At that time, data is written from a buffer memory to an HDD device and data to be transferred to another buffer memory is read out from the HDD device. In other words, two processes are simultaneously performed to the HDD device. An HDD controller module arbitrates the two processes.

In the above-mentioned known video signal recording and playback apparatus, when a user operates a plurality of video devices, e.g., HDD devices connected to each other via a predetermined interface, the user needs to display a control panel window as a graphical user interface in a monitor by operating a specific button on a remote control transmitter. For example, the control panel window has two phases, i.e., a control device selection window and an operation selection window. In the control device selection window, the user selects and determines a video device to be operated. After that, the user shifts the window to the operation selection window and then selects and determines an operation. In this instance, the control device means a video device to be controlled, i.e., a control target device. When the control device selection window is changed to the operation selection window, the initial position of a cursor is set to a fixed position, for example, on a power button. To perform chase play, therefore, the user needs to move the cursor from the initial position to a desired button required to activate chase play, namely, a chase play button. Since it is troublesome, the usability is low.

Japanese Unexamined Patent Application Publication No. 2001-167521 does not disclose a procedure of setting at least one of video devices connected via a predetermined interface so as to perform chase play.

### SUMMARY OF THE INVENTION

Accordingly, it is an object of the present invention to provide a video signal recording and playback apparatus, method, and system for checking respective operating states of a plurality of video device connected via a predetermined interface, expecting an operation which a user wants to perform, and performing the expected operation to simplify a user's operating procedure, resulting in the improvement of the usability.

According to a first aspect of the present invention, a video signal recording and playback system includes: a broadcasting receiver having a tuner for receiving a television broadcast signal, a demodulation section for demodulating the received broadcast signal into a video signal, and a control section for transmitting and receiving video signals to/from at least one external video device and controlling the video device; at least one video device connected to the broadcasting receiver via a predetermined interface; and a display section, connected to the broadcasting receiver, capable of displaying a user interface used to select and control the demodulated video signal and the operation of the video device. The control section of the broadcasting receiver includes: means for checking at least one video device connected via the predetermined interface to determine a video device which is recording; means for checking at least one video device connected via the predetermined interface to determine a video device capable of performing playback while recording; means for determining a video device, which is recording and is capable of performing playback while recording, at least one video device as a control target connected via the predetermined interface and determining playback with respect to the control target device in recording; and means for allowing the control target device in recording to perform the determined playback when an operation section is operated.

According to a second aspect of the present invention, a video signal recording and playback apparatus includes: means for checking at least one external video device connected to a main unit via a predetermined interface to determine a video device which is recording, the main unit having a control section for transmitting and receiving video signals to/from at least one video device and controlling the device; means for checking at least one video device connected via the predetermined interface to determine a video device capable of performing playback while recording; means for determining a video device, which is recording and is capable of performing playback while recording, at least one video device as a control target connected via the predetermined interface and determining playback with respect to the control target device in recording; and means for allowing the control target device in recording to perform the determined playback when an operation section is operated.

According to a third aspect of the present invention, a video signal recording and playback method comprising: checking at least one external video device connected to a main unit via a predetermined interface to determine a video device which is recording, the main unit having a control section for transmitting and receiving video signals to/from at least one video device and controlling the device; checking at least one video device connected via the predetermined interface to determine a video device capable of performing playback while recording; determining a video device, which is recording and is capable of performing playback while recording, at least one video device as a control target connected via the predetermined interface and determining playback with respect to the control target device in recording; and performing the determined playback through the control target device in recording when an operation section is operated.

According to the present invention, respective operating states of a plurality of video devices connected via a predetermined interface are checked, an operation which a user wants to perform, and the expected operation is performed, so that a user's operating procedure can be simplified, resulting in the improvement of the usability.

### BRIEF DESCRIPTION OF THE DRAWINGS

FIG. 1 is a block diagram of a video signal recording and playback system according to the present invention;

FIG. 2 shows a control panel window to explain the operation of a video signal recording and playback system according to a first embodiment of the present invention;

FIG. 3 is a flowchart of the operation of FIG. 2;

FIG. 4 is a flowchart of the detailed operation in step S2 of FIG. 3;

FIG. 5 is a flowchart of the detailed operation in step S4 of FIG. 3:

FIG. 6 is shows a control panel window to select a video device to be controlled from a plurality of candidate video devices;

FIG. 7 is a flowchart of the detailed operation in step S5 of FIG. 3;

FIGS. 8A to 8C show an operation example of a conventional control panel window, FIG. 8A explaining the selection of a control target device in a control device selection phase of the control panel window, FIG. 8B showing the initial position of a cursor in an operation selection phase of the control panel window, and FIG. 8C showing the control panel window in which a target operation is selected by moving the cursor;

FIGS. 9A and 9B show a control panel window on a monitor screen of a video signal recording and playback system according to a second embodiment of the present invention, FIG. 9A explaining the selection of a control target device in a control device selection phase of the control panel window, FIG. 9B showing the control panel window in which the position of a cursor automatically indicates a target operation after the cursor moves to an operation selection phase; and

FIG. 10 shows a representation in a monitor screen of a video signal recording and playback system according to a third embodiment of the present invention.

### DESCRIPTION OF THE PREFERRED EMBODIMENTS

Embodiments of the present invention will now be described with reference to the drawings.

### First Embodiment

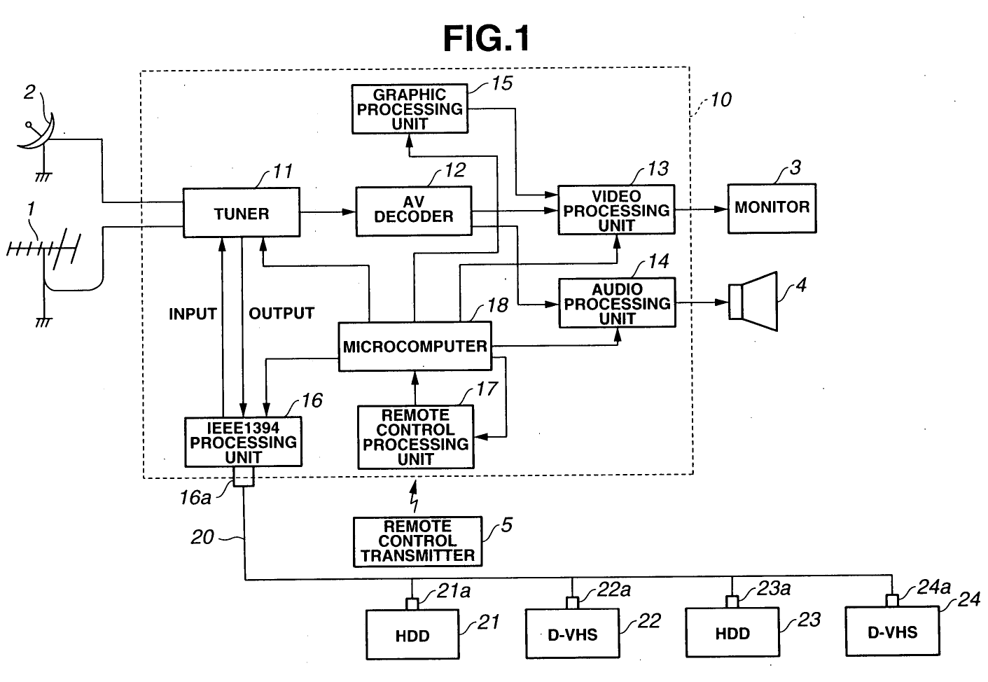

FIG. 1 is a block diagram of a video signal recording and playback system according to a first embodiment of the present invention.

Referring to FIG. 1, the video signal recording and playback system includes a set top box (STB) 10 functioning as a video signal recording and playback apparatus serving as a main unit of the system; video devices 21 to 24 connected to the STB 10 via a predetermined interface; a monitor 3, connected to the STB 10, serving as a display section capable of displaying video signals or a control panel window; a speaker 4 for generating audio signals; and a remote control transmitter 5 serving as an operation section. The STB 10 as the main unit includes demodulation section for demodulating a supplied video signal and control section for transmitting and receiving video signals to/from external video devices and controlling the devices.

The STB 10 includes, for example, a broadcasting receiver and has a tuner 11 therein. In the STB 10, a television broadcast signal including video and audio signals is received by an antenna 1 or 2 and is then supplied to the tuner 11, so that the signal is demodulated into a digital signal, which is obtained by multiplexing video data and audio data. Then, the demodulated digital signal is supplied to an AV decoder 12, thus decoding the video and audio data. The video data and the audio data are transmitted to the monitor 3 and the speaker 4, respectively. In this instance, for example, the antenna 1 is a receiving antenna for BS digital broadcast and the antenna 2 is a receiving antenna for digital terrestrial broadcast.

The STB 10 serves as the main unit of the video signal recording and playback system. The STB 10 has the tuner 11, the AV decoder 12, a video processing unit 13, an audio processing unit 14, a graphic processing unit 15, an IEEE1394 processing unit 16, a remote control processing unit 17, and a microcomputer 18. The tuner 11 receives, for example, a digital broadcast signal to demodulate the signal into a digital signal. The AV decoder 12, serving as the demodulation section, decodes compression-coded video and audio signals. The video processing unit 13 processes the video signal decoded through the AV decoder 12 to display video signal in the monitor 3 and processes a signal which is supplied from the graphic processing unit 15 and is used for a graphical user interface (GUI) representation. The audio processing unit 14 processes the audio signal decoded through the AV decoder 12 to generate the resultant signal to the speaker 4. The graphic processing unit 15 generates a graphic signal for the GUI representation, e.g., the control panel window in a monitor screen. The IEEE1394 processing unit 16 has an IEEE1394 terminal (also called an iLINK terminal) 16a and connects to at least one or more video devices to be controlled (e.g., an HDD device 21, a D-VHS device 22, an HDD device 23, and a D-VHS device 24) through an IEEE1394 cable (also called an iLINK cable) 20 in a daisy chain connection or a tree connection. The IEEE1394 processing unit 16 functions as an IEEE1394 serial interface through which recorded data and data to be played back can be received and transmitted between the tuner 11 in the STB 10 and the video devices. The remote control processing unit 17 receives a remote control signal of infrared radiation from the remote control transmitter 5. The microcomputer 18 serves as the control section for transmitting control signals to the components of the STB 10 and the externally connected video devices on the basis of an operation instruction based on the remote control signal received and processed through the remote control processing unit 17 to control the respective components and devices in order to perform the instructed operation. The microcomputer 18 transmits and receives video signals to/from the external video devices and controls the devices through the IEEE1394 processing unit 16.

The monitor 3 can display the GUI used to select and control the decoded video signal and the operation of each video device.

The IEEE1394 terminal 16a of the IEEE1394 processing unit 16 is connected to at least one or more video devices, i.e., the HDD device 21, the D-VHS device 22, the HDD device 23, and the D-VHS device 24 through the iLINK cable 20 in a daisy chain connection or a tree connection (FIG. 1 shows the daisy chain connection). The HDD device 21, the D-VHS device 22, the HDD device 23, and the D-VHS device 24 each have an IEEE1394 serial interface (IEEE1394 processing unit). The IEEE1394 processing units of those devices have iLINK terminals 21a, 22a, 23a, and 24a, respectively.

The remote control transmitter 5 has a power button, a channel up/down button for channel selection, an iLINK button for the control panel window, a decision button, and a cursor movement button (or an arrow key).

Referring to FIG. 1, the video devices connected to the STB 10 through the iLINK cable 20 are IEEE1394-compliant devices for transmitting and receiving AV streams and AV/C commands to/from the STB 10. The AV stream is transmitted and received between the tuner 11 in the STB 10 and each video device. The AV/C command is transmitted from the microcomputer 18 in the STB 10 to each video device functioning as the IEEE1394-compliant device. The AV stream includes video and audio data in the MPEG2-TS format. The AV/C command includes control data to control the device. The operation of each externally connected video device can be instructed and the operating state thereof can be obtained by using the AV/C command.

The video data and audio data are transmitted and received in an isochronous transfer mode. The AV/C command is transmitted in an asynchronous transfer mode. To grasp the respective operating states of the HDD devices 21 and 23, the STB 10 generates AV/C commands to the HDD devices 21 and 23, respectively. Thus, the STB 10 can obtain the respective operating states.

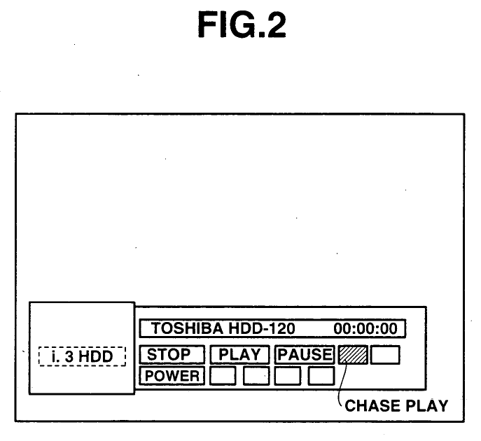

The operation of the system according to the first embodiment of the present invention will now be described with reference to FIGS. 2 to 7.

In the following description, recording means recording both video and audio signals.

In a case where a user operates the HDD device 23 which is connected to the STB 10 via the IEEE1394 serial interface and is currently recording, the system expects that in many cases, the user intends to perform chase play while the recording operation is going on. Consequently, when the user operates, for example, the “iLINK” button of the remote control transmitter 5 in order to display the control panel window, the control panel window is displayed on the monitor screen such that a cursor is initially positioned on a “Chase Play” button in the control panel window.

In other words, as shown in FIG. 2, when the user operates the “iLINK” button of the remote control transmitter 5 while the HDD device 23 is recording, in order to prompt the user to determine whether the user actually performs chase play, the control panel window is displayed and the cursor is simultaneously displayed in the monitor 3 such that the cursor is already positioned on the “Chase Play” button in the control panel window (the cursor position is shown by hatching).

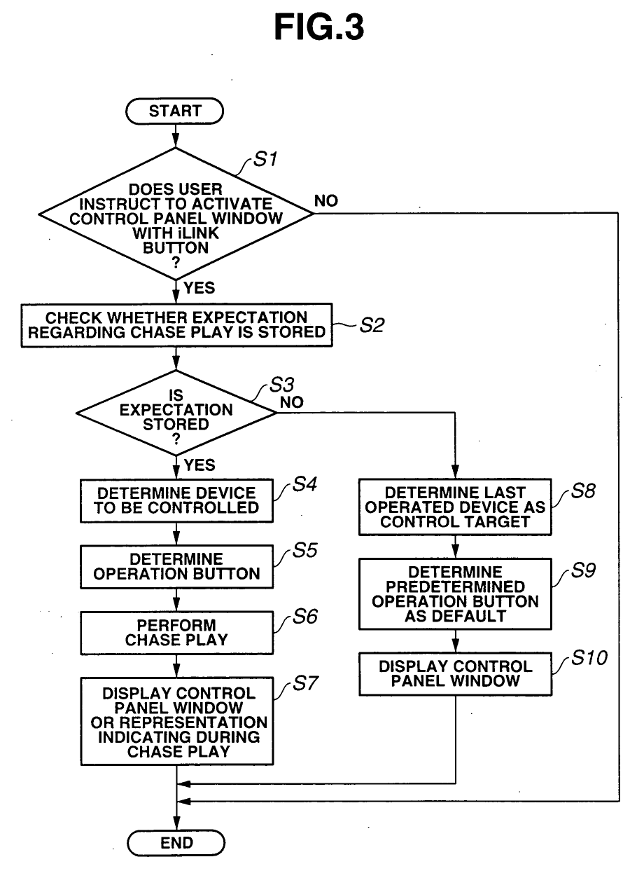

FIG. 3 is a flowchart of the operation in FIG. 2. The flowchart shows the operation in which the microcomputer 18 mainly operates.

The following explanation will be made on the assumption that the STB 10 is already turned on and the HDD device 23 connected via the IEEE1394 serial interface is recording.

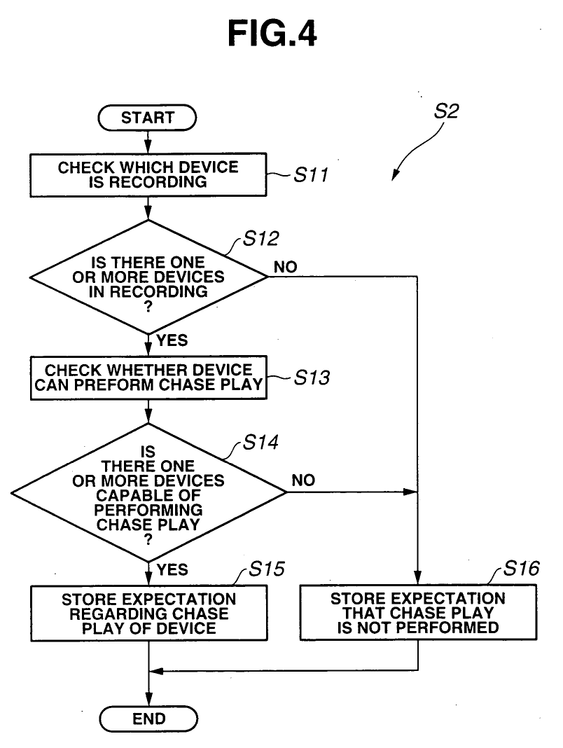

Referring to FIG. 3, whether the user presses the “iLINK” button (i.e., instructs to activate the control panel window) while the HDD device 23 is recording is determined (step S1). Subsequently, it is checked whether chase play with respect to the device in recording is expected (i.e., it is expected that the device is recording and is also capable of performing recording and playback) and a result of the expectation is stored in a memory of the microcomputer 18 (step S2). The detailed operation in step S2 will be described below with reference to FIG. 4. Whether the expectation result is stored is determined (step S3). If the expectation is stored, the operation proceeds to step S4. If NO, the operation proceeds to step S8.

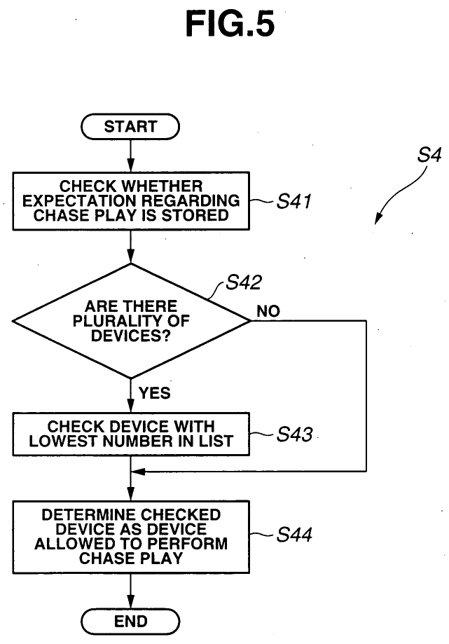

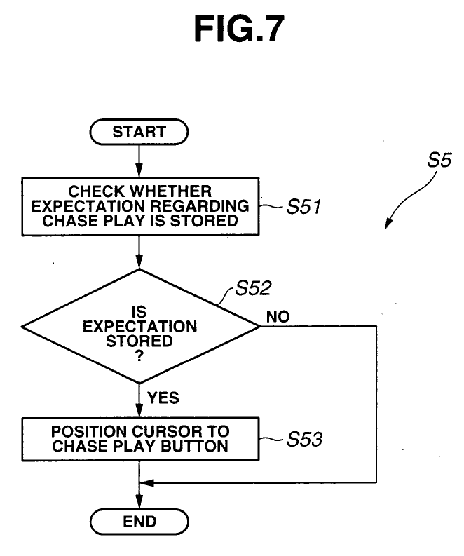

In step S4, which device is controlled is determined. The detailed operation in step S4 will be described below with reference to FIG. 5. Then, which operation button in the control panel window the cursor positioned is on is determined (step S5). Depending on the determination, the cursor is already positioned on the “Chase Play” button as shown in FIG. 2. The detailed operation in step S5 will be described below with reference to FIG. 7. In this instance, when the user presses the decision button, chase play is performed (step S6). A chase play window is displayed on the monitor 3 and the control panel window or a representation indicating during chase play is displayed (step S7).

If chase play is not expected in step S2 and the expectation is not stored in the memory in step S3, a device which the user last operated is determined as a control target device (step S8). A predetermined operation button (for example, a “Power” button to be operated during startup) in the control panel window is determined as a default (step S9). The control panel window is then displayed on the monitor 3 (step S10). The user can select and operate any operation button with reference to the control panel window to perform any operation.

FIG. 4 shows an example of the detailed operation in step S2 of FIG. 3.

First, which device connected via the IEEE1394 serial interface is recording is checked using AV/C commands (step S11). The operation enters step of expecting whether the user intends to perform chase play.

Whether there is one or more devices in recording is determined (step S12). If there is one or more devices, whether the device can perform chase play is determined (step S13). In other words, whether the device can perform recording and playback is determined. The reason is that chase play is impossible unless the device in recording is, for example, an HDD device capable of simultaneously performing recording and playback.

Whether there is one or more devices capable of performing chase play is determined (step S14). If there is at least one device capable of performing chase play, an expectation regarding chase play of the device is stored in the memory of the microcomputer 18 (step S15). If there is no device in step S12 or S14, an expectation that chase play is not performed is stored in the memory of the microcomputer 18 (step S16).

FIG. 5 shows an example of the detailed operation in step S4 of FIG. 3.

First, whether at least one expectation regarding chase play is stored in the memory is checked with reference to the memory (step S41). Then, whether there are a plurality of devices corresponding to the expectations, i.e., whether there are devices which can be allowed to perform chase play is checked (step S42).

If there are a plurality of devices in step S42, the order of the devices entered in a list of devices allowed to perform chase play (e.g., the device with the lowest number in the list in ascending order) is checked (step S43). Then, the device is automatically determined as a device to perform chase play (step S44). In other words, a device for chase play is automatically determined in accordance with a predetermined rule, e.g., the order of the device list.

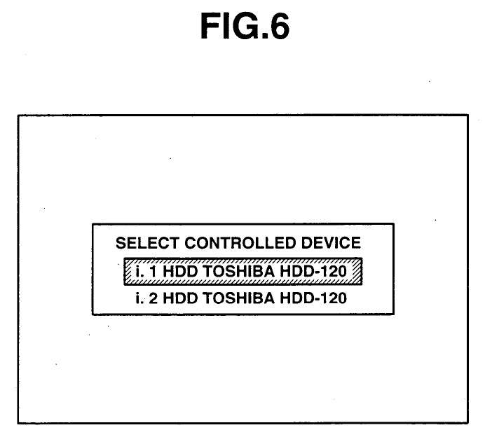

If there are a plurality of devices for chase play, the system enters a standby mode until the user operates any button. When the user operates, for example, the “iLINK” button of the remote control transmitter 5, the list of candidate devices to be controlled, i.e., devices for chase play can be displayed in the monitor 3 as shown in FIG. 6 instead of executing steps S43 and S44. The user can manually select and determine a device by operating the cursor movement button of the remote control transmitter 5.

FIG. 7 shows an example of the detailed operation in step S5 of FIG. 3.

First, whether at least one expectation regarding chase play is stored in the memory is checked with reference to the memory (step S51). Whether the expectation is stored in the memory is determined (step S52). If the expectation is stored in the memory in step S52, the cursor is positioned on the “Chase Play” button in the control panel displayed in the monitor 3 (step S53). Thus, when the user simply presses the decision button, chase play can be performed.

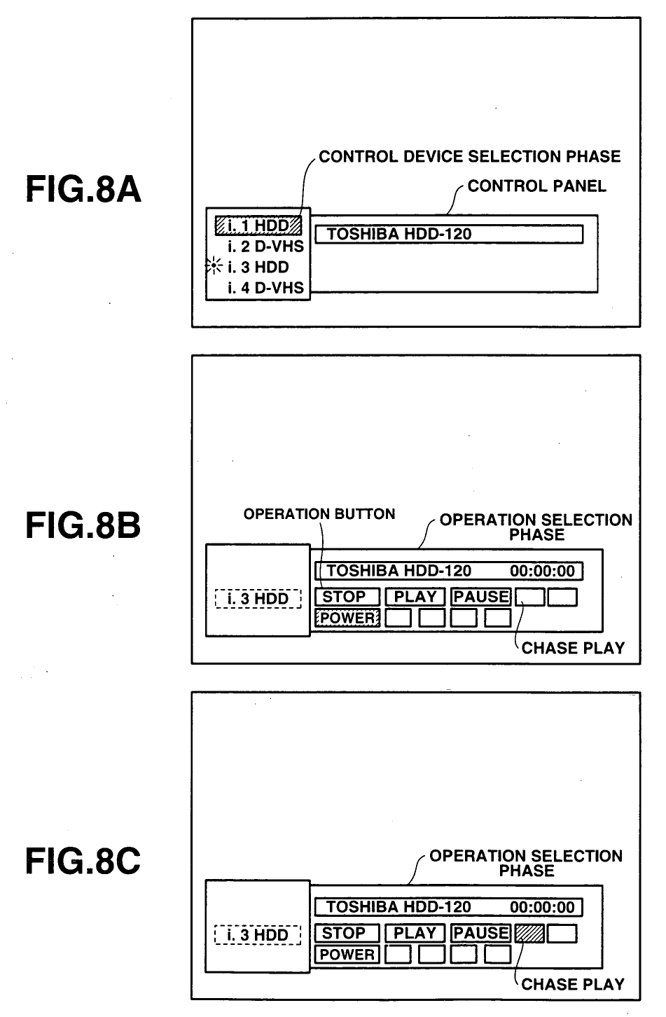

To compare the operation according to the first embodiment of the present invention with a conventional normal operation, the normal operation will now be described with reference to FIGS. 8A to 8C.

Referring to FIG. 8A, when the user operates a device connected via the IEEE1394 serial interface, the user displays a control panel window using a predetermined button of the remote control transmitter 5.

In this instance, the control panel window includes two phases, i.e., a control device selection phase and an operation selection phase. Symbols i.1 to i.4 in the control device selection phase in FIG. 8A indicate that there are a plurality of control target devices connected via the iLINK interface. In the control device selection phase in FIG. 8A, the user moves the cursor to select and determine a device to be controlled (“i.3 HDD” with a lighting mark “•” indicating during recording in FIG. 8A). In FIG. 8A, since a default of the cursor position related to a controlled device is set to “i.1” that is the lowest number, the user moves the cursor to “i.3 HDD” and presses the decision button of the remote control transmitter.

Then, the target phase is shifted to the operation selection phase for “i.3 HDD” as shown in FIG. 8B. The user moves the cursor to select any operation and determines the operation. In FIG. 8B, a default of the cursor position is set to the “Power” button. The user moves the cursor to the “Chase Play” button (refer to FIG. 8C).

When the user presses the decision button of the remote control transmitter in the state shown in FIG. 8C, the chase play operation of “i.3 HDD” starts.

As mentioned above, in the conventional normal operation, when the target phase is shifted from the control device selection phase to the operation selection phase, the initial position of the cursor is fixed to a specific position (the “Power” button in FIG. 8B). Accordingly, to perform chase play, the user needs to move the cursor to the “Chase Play” button as a desired button. It is troublesome.

According to the first embodiment of the present invention, the operating states of devices connected via the IEEE1394 serial interface are checked, the operation which the user wants to perform is expected, and the expected operation is executed. Thus, the procedure of the user's operation can be simplified, resulting in the improvement of usability.

### Second Embodiment

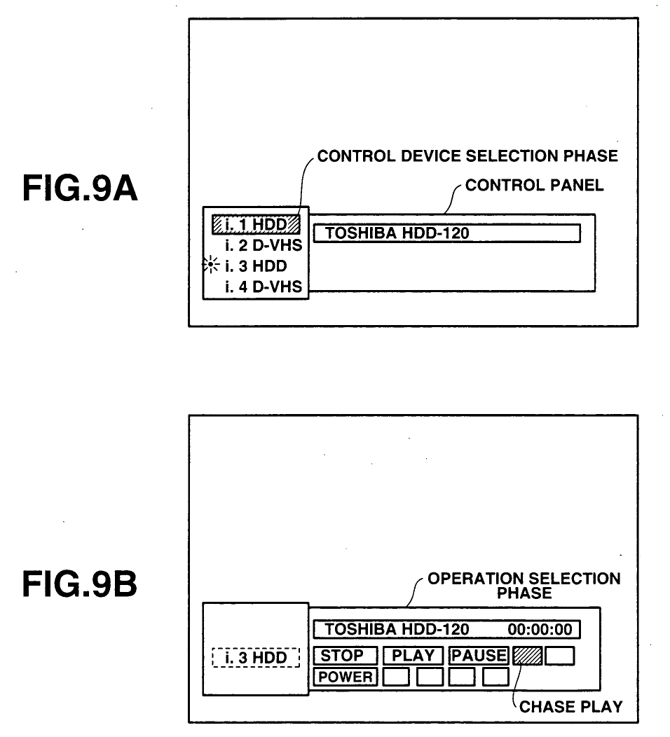

A video signal recording and playback system according to a second embodiment of the present invention will now be described. According to the second embodiment, in a case where the user operates the HDD device 23, which is connected to the IEEE1394 serial interface of the STB 10 and is currently recording, the system expects that in many cases, the user wants to perform chase play while the recording operation is continued. When the user operates, for example, the “iLINK button” of the remote control transmitter, the control panel window is first displayed. In this state, the user moves the cursor to “i.3 HDD” (refer to FIG. 9A) with a lighting mark “•” indicating during recording in the control device selection phase of the control panel window, and then presses the decision button of the remote control transmitter. As shown in FIG. 9B, the cursor is displayed on the monitor 3 such that the cursor is already positioned at the “Chase Play” button in the operation selection phase of the control panel window.

FIGS. 9A and 9B show the control panel window on the monitor screen in the video signal recording and playback system according to the second embodiment of the present invention.

Referring to FIG. 9A, when the user operates a device connected via the IEEE1394 serial interface, the user operates the “iLINK” button of the remote control transmitter 5 to display the control panel window in which the control device selection phase is first set to a target phase.

As mentioned above, the control panel window has two phases, i.e., the control device selection phase and the operation selection phase. In the control device selection phase of FIG. 9A, the user moves the cursor to select and determine a device to be controlled (“i.3 HDD” with a lighting mark “•” indicating during recording in FIG. 9A). Referring to FIG. 9A, a default of the cursor position related to a controlled device is set to “i.1” which is the lowest number. The user moves the cursor to “i.3 HDD” and then presses the decision button of the remote control transmitter.

As shown in FIG. 9B, the target phase is shifted to the operation selection phase regarding “i.3 HDD” and the cursor is automatically moved to the “Chase Play” button.

When the user presses the decision button of the remote control transmitter in the state of FIG. 9B, the chase play operation of “i.3 HDD” starts.

As mentioned above, according to the second embodiment of the present invention, different from the first embodiment, i.e., different from the operation of FIG. 2 in which the operation selection phase is immediately displayed as a target phase after the user operates the “iLINK” button of the remote control transmitter 5, the control device selection phase is first set as a target phase. When one of controlled devices in recording is selected in this phase, a stage before starting chase play in the operation selection phase is derived. Compared to the conventional operation in FIGS. 8A to 8C, the step shown in FIG. 8B is eliminated in the operation according to the second embodiment. Advantageously, the operation is simplified.

### Third Embodiment

A video signal recording and playback system according to a third embodiment of the present invention will now be described. According to the third embodiment, when the user operates the HDD device 23, which is connected to the STB 10 via the IEEE1394 serial interface and is currently recording, the system expects that in many cases, the user wants to perform chase play while the recording operation is continued. When the user operates the “iLINK button” of the remote control transmitter to activate the control panel window, chase play is immediately performed such that playback starts on the monitor screen.

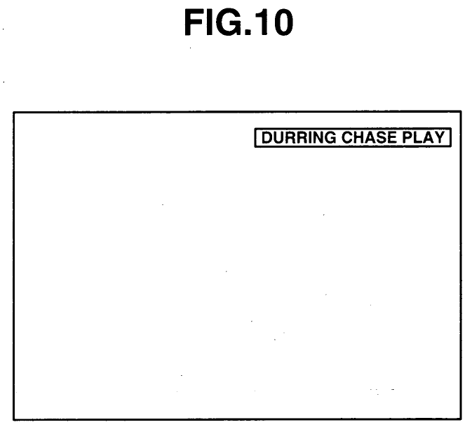

FIG. 10 shows display in the monitor screen of the video signal recording and playback system according to the third embodiment of the present invention.

In other words, when the user operates the “iLINK” button of the remote control transmitter while the HDD device 23 is recording, the control panel window is not displayed and only chase play is performed. At this time, since the control panel window is not displayed, preferably, a representation indicating “During Chase Play” or a similar icon is displayed on the screen of the monitor 3 in order to inform the user of such a state in which chase play is being performed.

According to the third embodiment of the present invention, when the user operates the “iLINK” button, the control panel window is not displayed and chase play can be immediately performed. Advantageously, a simple and easy operation can be accomplished.

As mentioned above, according to the present invention, the system provides means for expecting whether chase play is performed, so that the operation which the user desires can be performed soon. Further, the system provides means for directly moving a cursor to a desired operation button, so that the cursor can be immediately moved to the desired operation button. Further, the system provides means for searching for a device which is currently recording, so that a device for chase play can be automatically determined. Additionally, the system provides means for directly moving the cursor to a symbol indicating a desired device, so that the desired device can be immediately operated.

According to the present invention, a predetermined interface for connecting video device to the main unit is not limited to the IEEE1394 serial interface. In other words, the present invention is not limited to the embodiments in which at least one video device is connected to the main unit via the IEEE1394 serial interface (iLINK). The present invention can also be applied to a case where a video device is connected to the main unit through a universal serial bus (USB) as an interface.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. A video signal recording and playback system comprising:
a broadcasting receiver having a tuner for receiving a television broadcast signal, a demodulation section for demodulating the received broadcast signal into a video signal, and a control section for transmitting and receiving video signals to/from at least one external video device and controlling the video device;
at least one video device connected to the broadcasting receiver via a predetermined interface; and
a display section, connected to the broadcasting receiver, capable of displaying a user interface used to select and control the demodulated video signal and the operation of the video device, wherein
the control section of the broadcasting receiver includes:
means for checking at least one video device connected via the predetermined interface to determine a video device which is recording;
means for checking at least one video device connected via the predetermined interface to determine a video device capable of performing playback while recording;
means for determining a video device, which is recording and is capable of performing playback while recording, at least one video device as a control target connected via the predetermined interface and determining playback with respect to the control target device in recording; and
means for allowing the control target device in recording to perform the determined playback when an operation section is operated.

2. A video signal recording and playback apparatus comprising:
means for checking at least one external video device connected to a main unit via a predetermined interface to determine a video device which is recording, the main unit having a control section for transmitting and receiving video signals to/from at least one video device and controlling the device;
means for checking at least one video device connected via the predetermined interface to determine a video device capable of performing playback while recording;
means for determining a video device, which is recording and is capable of performing playback while recording, at least one video device as a control target connected via the predetermined interface and determining playback with respect to the control target device in recording; and
means for allowing the control target device in recording to perform the determined playback when an operation section is operated.

3. A video signal recording and playback apparatus according to claim 2, further comprising:
means for displaying a user interface in a display section connected to the main unit when an operation section is operated, the user interface presenting various operation modes including a mode corresponding to the determined playback so that the determined playback is selectable from among the operation modes;
wherein the control target device in recording performs the determined playback when the corresponding operation mode is selected in the user interface.

4. A video signal recording and playback apparatus according to claim 2, further comprising:
means for displaying a first user interface in a display section connected to the main unit when an operation section is operated, the first user interface presenting a list of the video devices connected via the predetermined interface so that a video device, which is capable of performing playback while recording and is recording, is selectable from the list; and
means for displaying a second user interface in the display section when the video device, which is capable of performing playback while recording and is recording, is selected in the first user interface, the second user interface presenting various operation modes including a mode corresponding to the determined playback so that the determined playback is selectable from the operation modes;
wherein the control target device in recording performs the determined playback when the corresponding operation mode is selected from the operation modes presented in the second user interface.

5. A video signal recording and playback method comprising:
checking at least one external video device connected to a main unit via a predetermined interface to determine a video device which is recording, the main unit having a control section for transmitting and receiving video signals to/from at least one video device and controlling the device;
checking at least one video device connected via the predetermined interface to determine a video device capable of performing playback while recording;
determining a video device, which is recording and is capable of performing playback while recording, at least one video device as a control target connected via the predetermined interface and determining playback with respect to the control target device in recording; and
performing the determined playback through the control target device in recording when an operation section is operated.

6. A video signal recording and playback method according to claim 5, further comprising:
displaying a user interface in a display section connected to the main unit when an operation section is operated, the user interface presenting various operation modes including a mode corresponding to the determined playback so that the determined playback is selectable from the operation modes;
wherein the control target device in recording performs the determined playback when the corresponding operation mode is selected from the operation modes presented in the user interface.

7. A video signal recording and playback method according to claim 5, further comprising:
displaying a first user interface in a display section connected to the main unit when an operation section is operated, the first user interface presenting a list of the video devices connected via the predetermined interface so that a video device, which is capable of performing playback while recording and is also recording, is selectable from the list; and
displaying a second user interface in the display section when the video device, which is capable of performing playback while recording and is also recording, is selected in the first user interface, the second user interface presenting various operation modes including a mode corresponding to the determined playback so that the determined playback is selectable from the operation modes;
wherein the control target device in recording performs the determined playback when the corresponding operation mode is selected from the operation modes presented in the second user interface.
